(19) United States
(12) Patent Application Publication
(10) Pub. No.: US 2020/0122310 A1
(43) Pub. Date: Apr. 23, 2020

(54) CHISEL

(71) Applicant: Hilti Aktiengesellschaft, Schaan (LI)

(72) Inventor: Steffen GEIGER, Muenchen (DE)

(21) Appl. No.: 16/266,964

(22) PCT Filed: Jul. 31, 2017
(86) PCT No.: PCT/EP2017/069300

§ 371 Date: Feb. 4, 2019

(30) Foreign Application Priority Data
Aug. 8, 2016 (EP) 16183147.4

(51) Int. Cl. B25D 17/02

(52) U.S. Cl. CPC B25D 17/02; B25D 2250/211; B25D 2222/72

(57) ABSTRACT

A chisel (1) has a shaft (2), an impact surface (5), a tip (3), a longitudinal axis (7) which extends through the impact surface (5) and the tip (3), and a working section (6). The working section (6) has a trunk (11) which is arranged on the longitudinal axis, and two wings (12) which extend along the trunk (11) and protrude radially from the trunk (11). The two wings (12) are arranged in a V shape.

### FIELD OF THE INVENTION

The present invention relates to a chisel for demolishing rock or mineral construction materials such as concrete and masonry.

### BACKGROUND

An example of a chisel for working mineral construction materials is disclosed in U.S. Pat. Appln. Publ. No. 2012/0301238. The chisel has a shank and a working end region that tapers to a point. The working end region has four elongate ribs that uniformly spread open the construction material when the chisel penetrates into the construction material.

### SUMMARY OF THE INVENTION

The present invention provides a-chisel having a shank, an impact surface, a tip, a longitudinal axis, which extends through the impact surface and the tip, and it also has a working section. The working section has a trunk which is arranged on the longitudinal axis, and two wings which extend along the trunk and protrude radially from the trunk. The two wings are arranged in a V shape. The chisel uses the trunk and the wings to spread the rock open. The V-shaped arrangement of the wings reduces sticking in the substrate in comparison to a pointed chisel, which has a rotationally symmetrical configuration. Since the chisel has a non-rotationally symmetrical shape, it generates not only radially acting forces to break the rock, but also non-radial forces that act along a vertical axis due to the wings.

The dihedral angle between the wings can be less than 180°. The dihedral angle indicates the relative slant of the wings with their V-shaped arrangement. The dihedral angle is measured between the connecting lines of the tips of the wings and the longitudinal axis in planes that are perpendicular to the longitudinal axis.

In one embodiment, in one area, the wings have a varying cross section along the longitudinal axis, whereby each of the cross sections in this area only partially overlaps the other cross sections. When any first cross section is compared to any second cross section, the first cross section has surfaces that project beyond the second cross section and, by the same token, the second cross section has surfaces that project beyond the first cross section.

In one embodiment, the dihedral angle increases from the shank to the tip. The wings are more markedly angled near the shank than in the area of the tip. At the tip, the wings can lie in a plane with the longitudinal axis, that is to say, they can have a dihedral angle of 180°.

In one embodiment, the working section does not exhibit a two-fold rotational symmetry around the longitudinal axis. The wings can be arranged mirror-symmetrically relative to a plane of symmetry comprising the longitudinal axis.

In one embodiment, the two wings are arranged mainly above a horizontal plane containing the longitudinal axis. The center of gravity or the wing tip is consistently on one side of the horizontal plane H.

In one embodiment, the wings are slanted along the longitudinal axis by a set angle relative to the longitudinal axis. Only the tops of the two wings facing in the same direction are in contact with the perforated wall, while the bottom is only partially or not at all in contact. This uneven support reduces the risk of the chisel sticking. The chisel undergoes a net force offset to the longitudinal axis and parallel to a vertical axis.

In one embodiment, a radial dimension of the two wings decreases from the shank to the tip.

In one embodiment, the trunk is configured so as to be essentially rotationally symmetrical. In one embodiment, the trunk is arranged coaxially relative to the longitudinal axis.

### BRIEF DESCRIPTION OF THE FIGURES

The description below explains the invention on the basis of embodiments and figures given by way of examples. The figures show the following:

FIG. 1 a chisel,

FIG. 2 a cross section through the chisel,

FIG. 3 a side view of the chisel,

FIG. 4 a cross section in the plane IV-IV,

FIG. 5 a cross section in the plane V-V,

FIG. 6 a cross section in the plane VI-VI,

FIG. 7 a cross section in the plane VII-VII,

FIG. 8 a cross section in the plane VIII-VIII,

FIG. 9 a cross section in the plane IX-IX,

FIG. 10 a cross section in the plane X-X,

FIG. 11 a cross section in the plane XI-XI.

Unless otherwise indicated, the same or functionally identical elements are designated in the figures by the same reference numerals.

### DETAILED DESCRIPTION OF EMBODIMENTS OF THE INVENTION

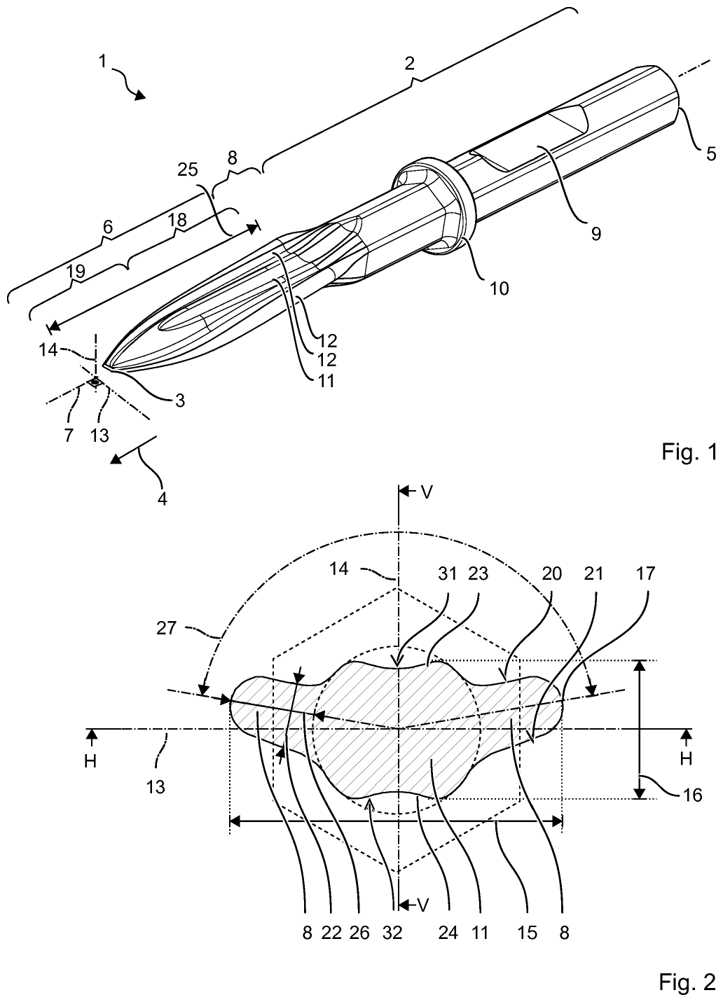

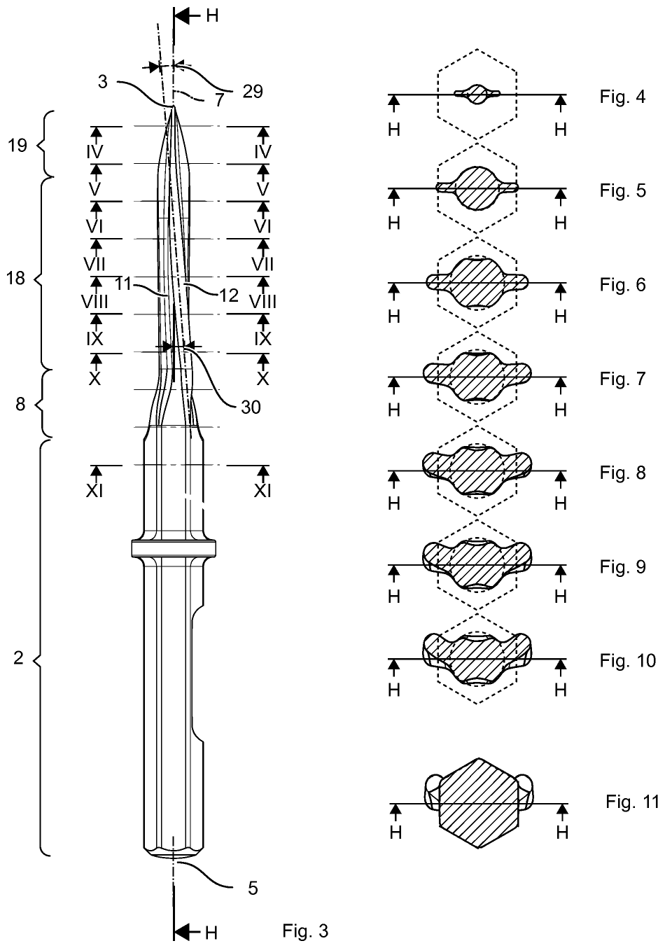

FIG. 1 shows an example of a pointed chisel 1. The user can insert the pointed chisel 1 with the shank 2 into an electric chisel. A tip 3 of the pointed chisel 1 is pressed against the substrate. The striking mechanism of the electric chisel strikes an impact surface 5 on the shank 2 in a striking direction 4. The shock wave of the impact passes through the shank 2 and through a working section 6 of the pointed chisel 1 and drives the tip 3 into the substrate.

The pointed chisel 1 has an elongated body. The narrow ends of the pointed chisel 1 are the impact surface 5 and the tip 3. A longitudinal axis 7 of the pointed chisel 1 runs through the impact surface 5 and the tip 3. The elongated body is divided along the longitudinal axis 7 into two sections, namely, the shank 2 and the working section 6. The shank 2 starts at the impact surface 5; the working section 6 ends at the tip 3. The shank 2 can be directly adjacent to the working section 6 or it can be connected to the working section 6 via a short transition area 8.

The shank 2 and the working section 6 differ in terms of their function and thus in terms of the associated geometric design. The shank 2 serves primarily to hold the pointed chisel 1 in a hand-held power tool. The geometric design is kept very simple and it is essentially uniform along the longitudinal axis, for example, it is cylindrical or prismatic, with a square or hexagonal cross section. The impact surface 5 forms the end face of the shank 2 that is bare and that faces away from the tip 3. The impact surface 5 can be dome-shaped. The shank 2 given by way of example has a groove 9 that is closed along the longitudinal axis 7. The shank 2 can be inserted into a tool socket of the electric chisel. A locking element, for example, a pawl or a ball, engages into the groove 9 and secures the pointed chisel 1 in the tool socket. The shank 2 given by way of example has a ring-shaped collar 10 that projects radially beyond the shank 2. Other tool sockets lock the pointed chisel 1 by means of a pivotable bracket that engages behind the collar 10 on the side of the tip 3. The shank 2 can have the groove 9 as well as the collar 10 or else only one of these two locking means.

The working section 6 penetrates into the mineral materials or rock during the demolition. The working section 6 is configured in order to efficiently break open a substrate and with the objective of reducing the tendency towards sticking in the substrate. The geometric design of the working section 6 is thus very different from the basic shape of the shank 2. In particular, the working section 6 is not rotationally symmetrical around the longitudinal axis 7. The working section 6 has a trunk 11 and exactly two wings 12 that protrude radially from the trunk 11. The trunk 11 is on the longitudinal axis 7. The wings 12 are arranged in a V shape. The two wings 12 preferably have an identical design and are preferably arranged mirror-symmetrically relative to each other.

A coordinate system is introduced for the description of the working section 6. The coordinate system is oriented towards a cuboid that circumscribes the working section 6 and that has a longitudinal axis 7, a crosswise axis 13 and a vertical axis 14. The three axes are orthogonal relative to each other and intersect at one point. The longitudinal axis 7 is defined by the connecting line running from the tip 3 to the middle of the impact surface 5. The terms “axial” and “radial” refer to the longitudinal axis 7. The crosswise axis 13 and the vertical axis 14 correspond to the directions starting from the longitudinal axis 7 where the dimension of the working section 6 parallel to the crosswise axis 13 (width 15) is at its maximum and where the dimension of the working section 6 parallel to the vertical axis 14 (height 16) is at its minimum. The crosswise axis 13 is parallel to a connecting line of the opposing wing tips 17. The length 25 of the working section 6 is preferably much greater than the width 15 of the working section 6, for example, five times greater. The width 15 of the working section 6 is preferably greater than the height 16, for example, one and a half times greater. The plane formed by the longitudinal axis 7 and the crosswise axis 13 is referred to below as the horizontal plane H, and the plane formed by the longitudinal axis 7 and the crosswise axis 14 is referred to below as the vertical plane V. The working section 6 is asymmetrical relative to the horizontal plane H. The working section 6 is preferably configured to be mirror-symmetrical relative to the vertical plane V.

The working section 6 given by way of example has a guiding area 18 having a width 15 along the longitudinal axis 7 that is constant (FIGS. 6 to 10) and a tip area 19 having a width 15 along the longitudinal axis 7 that decreases towards the tip 3 (FIGS. 4 to 6).

The trunk 11 is an essentially rod-shaped element with a circular cross section that tapers in a cone-like manner in the area of the tip 3. The tip of the trunk 11 forms the tip 3 of the pointed chisel 1. The cross section of the trunk 11 can also be elliptical with an aspect ratio of 1:1.2 at the maximum. The trunk 11 defines the longitudinal axis 7 of the chisel 1. The trunk 11 and the longitudinal axis 7 are coaxial.

The wings 12 given by way of example are essentially plate-shaped elements, each having a top 20, a bottom 21 and a wing tip 17. The wing tip 17 refers to the outer radial edge of the wings 12.

A thickness 22 of the wings 12—that is to say, the local distance from the top 20 to the bottom 21—is much smaller than the height 16 of the trunk 11 or of the working section 6. The thickness 22 can be largely constant in the radial direction. The top 20 and the bottom 21 can be said to be approximately parallel. The top 20 and the bottom 21 can be planar or else they can have an approximately identical curvature along the radial direction. The wings 12 directly adjoin the trunk 11. The wings 12 divide the surface of the trunk 11 into a back 23 and a front 24. The back 23 lies above a horizontal plane H, and the front 24 lies below the horizontal plane H. The horizontal plane H is perpendicular to the vertical axis 14 and it runs between the longitudinal axis 7 and the crosswise axis 13.

Preferably, the wings 12 extend over the entire length 25 or over most of the working section 6. The axial dimension of the wings 12 is much greater than its radial dimension, that is to say, the axial dimension is at least five times greater than the radial dimension. The radial dimension 26 of the wings 12 and the radius of the trunk 11 are approximately equal, for example, they exhibit a relative difference of less than 25%. The radial dimension 26 of the wings 12 decreases from the tip 3 to the shank 2 preferably in the same manner as the radius of the conical trunk 11. The ratio of the dimensions can be constant.

The center of gravity of the wings 12 lies above the horizontal plane H. The wings 12 are arranged mostly above the horizontal plane H, that is to say, the portion of the wing 12 above the horizontal plane H is larger than the portion of the wing 12 below the horizontal plane H. A line through the geometric centers of the wings 12 in the consecutive cross sections can lie on the horizontal plane H in certain sections, especially near the tip 3, and otherwise it lies above the horizontal plane H. From the shank 2 to the tip 3, the wing tips 17 lie on and above the horizontal plane H, but not below the horizontal plane H.

The two wings 12 are arranged in a V shape, especially in the guiding area 18. The dihedral angle 27 between the two wings 12 is less than 180°. The dihedral angle 27 is between 120° and 170°. The dihedral angle 27 is determined in the circumferential direction around the longitudinal axis 7. Owing to the V-shaped arrangement of the wings 12, the working section 6 is not rotationally symmetrical. The working section 6 does not exhibit a two-fold rotational symmetry around the longitudinal axis 7, whereby such a rotational symmetry would cause the working section 6 to coincide with itself if the latter were to be rotated by 180°. Moreover, owing to the V-shaped arrangement of the wings 12, the working section 6 is not arranged mirror-symmetrically relative to the horizontal plane H.

The relative V-shaped positioning of the two wings 12 with respect to each other can increase in the direction leading from the tip 3 towards the shank 2. The dihedral angle 27 is preferably constant in the tip area 19. The dihedral angle 27 remains constant whereas the width 15 changes. The wings 12 can lie in a plane, for example, the horizontal plane H. The dihedral angle 27 is, for example, between 170° and 180°, preferably 180°. In the guiding area 18, the dihedral angle 27 decreases continuously. Adjacent to the shank 2, the dihedral angle 27 is minimal and it is in a range between 120° and 150°. The width 15 of the working section 6 is preferably constant when the dihedral angle 27 changes.

The wings 12 are tilted relative to the longitudinal axis 7 by a set angle 29. The set angle 29 can be seen in the side view. The wing tips 17 lie in a plane that is slanted relative to the longitudinal axis 7 by the set angle 29. A vertical distance 30, that is to say, along the vertical axis 14, of the wing tips 17 to the horizontal plane H preferably increases continuously from the tip 3 to the shank 2, especially within the guiding area.

The tops 20 of the wings 12 and the front 24 of the trunk 11 of the working section 6 are in contact with the perforated wall in the substrate. The bottoms 21 of the wings 21 are at a distance from the perforated wall. If the bottoms 21 are in contact with the perforated wall, they exert less force on the perforated wall than the tops 20 do.

The back 23 can be provided with an indentation 31 in an area that is adjacent to the shank 2. The indentation 31 is preferably symmetrical to the vertical plane V. The indentation 31 forms a concave surface on the back 23. The radial distance from the surface of the indentation 31 to the longitudinal axis 7 in the area 18 amounts to between 66% and 85% of the radius of the trunk 11.

The front 24 can be provided with an indentation 32 in an area that adjoins the shank 2. The indentation 32 is preferably symmetrical to the vertical plane V. The indentation 32 forms a concave surface on the front 24. The radial distance from the surface of the indentation 32 to the longitudinal axis 7 in the area 18 amounts to between 66% and 85% of the radius of the trunk 11.

What is claimed is:

1-10. (canceled)

11. A chisel comprising:
a shank;
an impact surface;
a tip;
a longitudinal axis extending through the impact surface and the tip;
a working section having a trunk arranged on the longitudinal axis; and
two wings extending along the trunk and protruding radially from the trunk, the two wings being arranged in a V shape.

12. The chisel as recited in claim 11 wherein the dihedral angle between the wings is less than 180°.

13. The chisel as recited in claim 12 wherein the dihedral angle increases from the shank to the tip in an area.

14. The chisel as recited in claim 11 wherein in one area, the wings have a varying cross section along the longitudinal axis, each of the cross sections in the one area only partially overlapping the other cross sections.

15. The chisel as recited in claim 11 wherein the working section does not exhibit a two-fold rotational symmetry around the longitudinal axis.

16. The chisel as recited in claim 11 wherein the wings are arranged mirror-symmetrically relative to a plane of symmetry including the longitudinal axis.

17. The chisel as recited in claim 11 wherein the two wings are arranged mainly above a horizontal plane including the longitudinal axis.

18. The chisel as recited in claim 11 wherein the wings are slanted along the longitudinal axis by a set angle relative to the longitudinal axis.

19. The chisel as recited in claim 11 wherein a radial dimension of the two wings decreases from the shank to the tip.

20. The chisel as recited in claim 11 wherein the trunk is configured so as to be essentially rotationally symmetrical relative to the longitudinal axis.
